(19) United States
(12) Patent Application Publication
(10) Pub. No.: US 2026/0261643 A1
(43) Pub. Date: Sep. 3, 2026

(54) NAKED-EYE 3D DISPLAY ADJUSTMENT METHOD AND ELECTRONIC DEVICE

(71) Applicant: Lenovo (Beijing) Limited, Beijing (CN)

(72) Inventors: Wanjun LV, Beijing (CN); Xilong ZHOU, Beijing (CN); Wei JING, Beijing (CN)

(21) Appl. No.: 19/535,585

(22) Filed: Feb. 10, 2026

(30) Foreign Application Priority Data
Feb. 28, 2025 (CN) 202510232674.2

(51) Int. Cl. H04N 13/327; H04N 13/305; H04N 13/31; H04N 13/383; H04N 13/398

(52) U.S. Cl. CPC H04N 13/327; H04N 13/305; H04N 13/31; H04N 13/383; H04N 13/398

(57) ABSTRACT

A naked-eye 3D display adjustment method includes, in response to receiving an adjustment operation for a naked-eye 3D display window, performing semantic analysis on a naked-eye 3D image to determine an in-depth semantic analysis result, based on the adjustment operation, determining target position information of the naked-eye 3D display window, based on the in-depth semantic analysis result and the target position information, adjusting directional backlight array control information and the naked-eye 3D image, and based on the adjusted directional backlight array control information, displaying the adjusted naked-eye 3D image. The directional backlight array control information is used to implement naked-eye 3D display of the naked-eye 3D image.

### CROSS-REFERENCES TO RELATED APPLICATION

This application claims priority to Chinese Patent Application No. 202510232674.2, filed on Feb. 28, 2025, the entire content of which is incorporated herein by reference.

### FIELD OF TECHNOLOGY

The present disclosure relates to the field of naked-eye 3D display technology and, more particularly, to a naked-eye 3D display adjustment method and an electronic device.

### BACKGROUND

With the rapid development of display technology, 3D display technology has been widely applied in entertainment, education, and medical fields. The naked-eye 3D display technology provides the user with the experience of viewing a 3D image or video with the naked eye without wearing a device, and has become a new trend.

However, the related naked-eye 3D display solution still has certain limitations. For example, the naked-eye 3D viewing experience of the user will decrease during the process of performing an adjustment operation on the naked-eye 3D display content.

### SUMMARY

One aspect of this disclosure provides a naked-eye 3D display adjustment method. The method includes, in response to receiving an adjustment operation for a naked-eye 3D display window, performing semantic analysis on a naked-eye 3D image to determine an in-depth semantic analysis result, based on the adjustment operation, determining target position information of the naked-eye 3D display window, based on the in-depth semantic analysis result and the target position information, adjusting directional backlight array control information and the naked-eye 3D image, and based on the adjusted directional backlight array control information, displaying the adjusted naked-eye 3D image. The directional backlight array control information is used to implement naked-eye 3D display of the naked-eye 3D image.

Another aspect of this disclosure provides an electronic device, including a naked-eye 3D display and at least one processor. The at least one processor is configured to in response to receiving an adjustment operation for a naked-eye 3D display window, perform semantic analysis on a naked-eye 3D image to determine an in-depth semantic analysis result, based on the adjustment operation, determine target position information of the naked-eye 3D display window, based on the in-depth semantic analysis result and the target position information, adjust directional backlight array control information and the naked-eye 3D image, and based on the adjusted directional backlight array control information, displaying the adjusted naked-eye 3D image. The naked-eye 3D display includes a directional backlight array, and the directional backlight array is configured for naked-eye 3D display. The directional backlight array control information is used to implement naked-eye 3D display of the naked-eye 3D image.

Another aspect of this disclosure provides a computer-readable storage medium storing program codes that, when executed by one or more processors, cause the one or more processors to, in response to receiving an adjustment operation for a naked-eye 3D display window, perform semantic analysis on a naked-eye 3D image to determine an in-depth semantic analysis result, based on the adjustment operation, determine target position information of the naked-eye 3D display window, based on the in-depth semantic analysis result and the target position information, adjust directional backlight array control information and the naked-eye 3D image, and based on the adjusted directional backlight array control information, display the adjusted naked-eye 3D image. The directional backlight array control information is used to implement naked-eye 3D display of the naked-eye 3D image.

### BRIEF DESCRIPTION OF THE DRAWINGS

Through the description of embodiments of the present disclosure with reference to the accompanying drawings, the above and other purposes, features, and advantages of the present disclosure are clearer.

FIG. 1 is a schematic diagram showing naked-eye 3D display principle according to some embodiments of the present disclosure.

FIG. 2 is a schematic diagram of an application scenario of a naked-eye 3D adjustment method and an electronic device according to some embodiments of the present disclosure.

FIG. 3 is a schematic flowchart of a naked-eye 3D adjustment method according to some embodiments of the present disclosure.

FIG. 4A is a schematic diagram of performing an adjustment operation on a naked-eye display window according to some embodiments of the present disclosure.

FIG. 4B is a schematic diagram of performing another adjustment operation on a naked-eye display window according to some embodiments of the present disclosure.

FIG. 5 is a schematic diagram of a naked-eye 3D image according to some embodiments of the present disclosure.

FIG. 6A is a schematic diagram showing a width of a zero-plane area according to some embodiments of the present disclosure.

FIG. 6B is a schematic diagram of a target 3D mode area according to some embodiments of the present disclosure.

FIG. 6C is a schematic diagram of another target 3D mode area according to some embodiments of the present disclosure.

FIG. 7 is a schematic diagram of a left-eye image and a right-eye image before adjustment and a left-eye image and a right-eye image after adjustment according to some embodiments of the present disclosure.

FIG. 8 is a schematic block diagram of an electronic device according to some embodiments of the present disclosure.

### DETAILED DESCRIPTION

Embodiments of the present disclosure are described with reference to the accompanying drawings. However, the description is merely exemplary and is not intended to limit the scope of the present disclosure. In addition, in the following description, descriptions of well-known structures and technologies are omitted to avoid unnecessarily obscuring the concepts of the present disclosure.

The terms used here are only for describing specific embodiments and are not intended to limit the present disclosure. The terms “include” and “contain” used here indicate the presence of stated features, steps, operations, and/or components, but do not preclude the presence or addition of one or more other features, steps, operations, or components.

All terms used here (including technical and scientific terms) have the meanings commonly understood by those skilled in the art, unless otherwise defined. The terms used here should be interpreted as having meanings consistent with the context of the present specification, and should not be interpreted in an idealized or overly rigid manner.

When expressions such as “at least one of A, B, and C” are used, they should generally be interpreted according to the meaning commonly understood by those skilled in the art (for example, “a system having at least one of A, B, or C” should include, but is not limited to, only A, only B, only C, A and B, A and C, B and C, and/or A, B, and C).

In the technical solutions of the present disclosure, the user information involved (including but not limited to user personal information, user image information, user device information, such as location information, etc.) and data (including but not limited to data used for analysis, stored data, displayed data, etc.) are information and data that have been authorized by the user or fully authorized by all relevant parties. The collection, storage, use, processing, transmission, provision, disclosure, and application of the relevant data comply with relevant laws, regulations, and standards, necessary confidentiality measures are adopted, public order and good morals are not violated, and corresponding operation entries are provided for the user to choose authorization or refusal.

Some block diagrams and/or flowcharts are shown in the accompanying drawings Some blocks or a combination thereof in the block diagrams and/or flowcharts may be implemented by computer program instructions. These computer program instructions can be provided to a processor of a general-purpose computer, a special-purpose computer, or another programmable data processing apparatus, such that the instructions, when executed by the processor, create an apparatus for implementing the functions/operations specified in the block diagrams and/or flowcharts.

Therefore, the technology of the present disclosure may be implemented in the form of hardware and/or software (including firmware, microcode, etc.). In addition, the technology of the present disclosure may take the form of a computer program product on a computer-readable medium having instructions stored thereon. The computer program product may be used by or in combination with an instruction execution system. In the context of the present disclosure, the computer-readable medium may be any medium that can contain, store, convey, propagate, or transmit instructions. For example, the computer-readable medium may include, but is not limited to, electrical, magnetic, optical, electromagnetic, infrared, or semiconductor systems, apparatuses, devices, or propagation media. Specific examples of the computer-readable medium may include magnetic storage apparatuses, such as magnetic tapes or hard disk drives (HDDs), optical storage apparatuses, such as optical disks (CD-ROMs), memories, such as random access memory (RAM) or flash memory, and/or wired/wireless communication links.

With the rapid development of display technology, 3D display technology has been widely applied in fields such as entertainment, education, and medical care. The naked-eye 3D display technology aims to provide users with a viewing experience of 3D images or videos with the naked eye without wearing a device, and is gradually becoming a new development trend.

In embodiments of the present disclosure, a naked-eye 3D display can be realized based on a directional backlight technology. By simulating the binocular parallax principle of human eyes and using a directional backlight array and a high refresh rate display screen, left-eye images and right-eye images with parallax can be accurately projected to the left eye and right eye of the viewer, respectively. By fusing the images in the brain, a stereoscopic visual effect can be achieved.

FIG. is a schematic diagram showing a naked-eye 3D display principle according to some embodiments of the present disclosure.

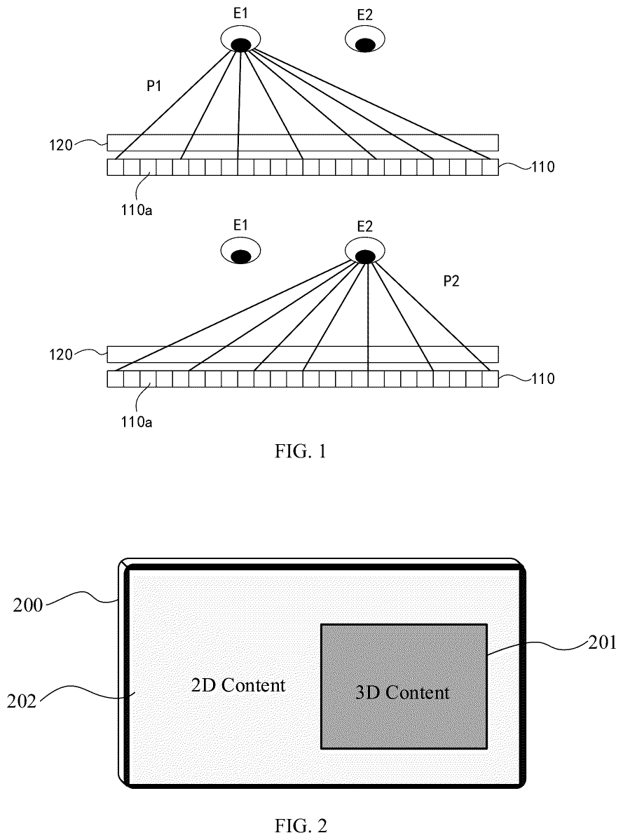

As shown in FIG. 1, a naked-eye 3D display system includes, for example, a directional backlight array 110 and a display panel 120. The directional backlight array 110 can modulate light beams into directional light to ensure that light can be accurately projected to a designated area. Thus, the directional backlight array 110 can be used to allow the left-eye image P1 to enter the left eye E1 of the viewer and the right-eye image P2 to enter the right eye E2 of the viewer. Based on the binocular parallax principle, when the left eye E1 and the right eye E2 of the viewer receive the left-eye image P1 and the right-eye image P2 with parallax, respectively, the brain can determine the spatial depth of objects by fusing the two parallax images to form stereoscopic vision.

In some embodiments, the naked-eye 3D display system can control the left-eye image P1 to accurately enter the left eye E1 and control the right-eye image P2 to accurately enter the right eye E2 by switching the left-eye image P1 and the right-eye image P2 at a high speed and alternately activating the left-eye directional function and the right-eye directional function of the directional backlight array 110 at a high speed. For example, when the left-eye image P1 is displayed, directional backlight units corresponding to the left-eye viewing area can be turned on, and directional backlight units corresponding to the right-eye viewing area can be turned off, so that the left eye E1 can see the left-eye image P1. For example, when the right-eye image P2 is displayed, the directional backlight units corresponding to the right-eye viewing area can be turned on, and the directional backlight units corresponding to the left-eye viewing area can be turned off, so that the right eye E2 can see the right-eye image P2. Through such alternate turning on and off of the directional backlight units (similar to refreshing the directional backlight array in a flashing manner), the left eye E1 and right eye E2 of the viewer can be ensured to alternately receive the left-eye image P1 and the right-eye image P2 displayed on the display panel 120. By utilizing the persistence of vision principle, the brain can fuse the left-eye image P1 and the right-eye image P2 to produce stereoscopic vision.

For example, as shown in FIG. 1, the directional backlight array 110 includes a plurality of independently controllable directional backlight units 110a. Each directional backlight unit 110a can include, for example, a backlight unit and an optical modulation assembly. The backlight unit can be selected from at least one of a point light source or a surface light source. The optical modulation assembly can include, for example, a lens and a diffusion film.

The naked-eye 3D display system can be implemented based on any naked-eye 3D display technical principle, e.g., directional backlight technology, parallax barrier technology, light-field display technology, or multi-view display technology. In embodiments of the present disclosure, the naked-eye 3D display principle or the hardware structure for implementing the naked-eye 3D display principle is not limited.

In embodiments of the present disclosure, the naked-eye 3D display content can be windowed. For example, a 3D content can be displayed through a 3D content display area (for example, a naked-eye 3D display window), and a 2D content can be displayed through a 2D content display area. Then, both of the 3D content and 2D content can be displayed on the same screen. Display control information corresponding to the 3D content display area and display control information corresponding to the 2D content display area can be significantly different.

In implementing the inventive concept of the present disclosure, the inventors have found that during adjustment operations such as translation and scaling of the naked-eye 3D display window, since the adjustment operations may affect the position and size of the naked-eye 3D display window, the naked-eye 3D display effect may be lost or become inaccurate during the adjustment process. Thus, the naked-eye 3D viewing experience of the viewer can be reduced. Based on this, how to maintain the naked-eye 3D viewing experience of the viewer during the process of performing the adjustment operation on the naked-eye 3D display window needs to be solved.

Embodiments of the present disclosure provide a naked-eye 3D display adjustment method and an electronic device. The method can include, in response to receiving an adjustment operation for a naked-eye 3D display window, performing semantic analysis on a naked-eye 3D image to determine an in-depth semantic analysis result, determining target position information of the naked-eye 3D display window based on the adjustment operation, adjusting directional backlight array control information and the naked-eye 3D image based on the in-depth semantic analysis result and the target position information, the directional backlight array control information being used to implement naked-eye 3D display of the naked-eye 3D image, and displaying the adjusted naked-eye 3D image based on the adjusted directional backlight array control information.

FIG. 2 is a schematic diagram of an application scenario of the naked-eye 3D adjustment method and the electronic device according to some embodiments of the present disclosure.

As shown in FIG. 2, the application scenario of embodiments of the present disclosure includes an electronic device 200. The electronic device 200 can be any electronic device capable of implementing a naked-eye 3D display. For example, the electronic device 200 can include, but is not limited to, a display, a smartphone, a netbook, a tablet computer, a handwriting tablet, a smart watch, a smart band, a phone watch, a smart camera, a palmtop computer, an in-vehicle computer, a personal computer (PC), a personal digital assistant (PDA), a portable multimedia player (PMP), an augmented reality (AR)/virtual reality (VR) device, a smart television, a projection device, or a somatosensory game console in a human-computer interaction scenario. Alternatively, the electronic device 200 may be another type or structure of electronic device capable of implementing naked-eye 3D display, which is not specifically limited here.

In embodiments of the present disclosure, the electronic device 200 can display a naked-eye 3D image in a naked-eye 3D display window 201 based on the directional backlight technology. The naked-eye 3D image can include a left-eye image and a right-eye image, and parallax can exist between the left-eye image and the right-eye image.

In embodiments of the present disclosure, for the same object A, if the x-axis coordinate of the object in the left-eye image is x1 and the x-axis coordinate of the object in the right-eye image is x2, the parallax between the left-eye image and the right-eye image can be understood as a difference Δx between x1 and x2. Based on the binocular parallax principle, the parallax Δx can be proportional to the depth of the feature A. If the sizes of the left-eye image and the right-eye image change (such as zoom in or zoom out), the parallax Δx can also change accordingly to change the depth of the object A.

For example, the electronic device 200 can include a directional backlight array. The directional backlight array can include a plurality of independently controllable directional backlight units. The directional backlight array can be compatible with a 3D display mode and a 2D display mode. For example, in the 3D display mode, the directional backlight array can modulate directional light for 3D display. For example, in the 2D display mode, the directional backlight array can provide uniform background light for 2D display.

In embodiments of the present disclosure, the electronic device 200 can display 3D content through a 3D content display area (for example, a naked-eye 3D display window), and display 2D content through a 2D content display area. Thus, both 3D content and 2D content can be displayed on the same screen. For example, directional backlight units arranged corresponding to the 3D content display area can be set to the 3D display mode, and directional backlight units arranged corresponding to the 2D content display area can be set to the 2D display mode.

As shown in FIG. 2, the electronic device 200 displays a naked-eye 3D display window 201. The electronic device 200 can display 3D content through the naked-eye 3D display window 201 and display 2D content through a 2D content display area 202. Thus, both 3D content and 2D content can be displayed on the same screen. For example, the naked-eye 3D display window 201 can be an image viewer window, and the 2D content display area 202 can be a browser page. The user can view a naked-eye 3D image through the image viewer window while viewing a 2D image on the browser page, such that the naked-eye 3D image and the 2D image can be displayed on the same screen.

In some embodiments, the directional backlight array can include a 3D mode area arranged corresponding to the naked-eye 3D display window 201, and a 2D mode area arranged corresponding to the 2D content display area 202. For each directional backlight unit in the 2D mode area, uniform illumination can be maintained to achieve a 2D display effect. For each directional backlight unit in the 3D mode area, the directional backlight array can be refreshed based on a preset flickering frequency. Moreover, in cooperation with a high refresh-rate display panel, the left-eye image and the right-eye image can alternately and rapidly enter the left eye and right eye of the viewer to realize the naked-eye 3D display effect.

In embodiments of the present disclosure, the user can perform an adjustment operation on the naked-eye 3D display window 201. For example, the user may perform a translation operation and a scaling operation on the naked-eye 3D display window 201. For example, the user can translate or scale the naked-eye 3D display window through a touch operation, a mouse operation, a keyboard operation, or a gesture operation, which are not specifically limited here.

For example, the user can perform the translation operation on the naked-eye 3D display window 201. When the moving speed is greater than a preset refresh frequency of the directional backlight units, if the 3D mode area of the directional backlight array cannot be adjusted in time, a portion of the content within the naked-eye 3D display window 201 may lose the 3D display effect during the movement process.

For another example, the user can perform a scaling operation on the naked-eye 3D display window 201. When the size of the naked-eye 3D display window 201 changes, if the size of the naked-eye 3D image within the naked-eye 3D display window 201 only changes proportionally in a simple manner, the parallax between the left-eye image and the right-eye image can change significantly. For example, when the naked-eye 3D display window 201 is enlarged, the parallax between the left-eye image and the right-eye image can increase significantly, which can cause user dizziness. For example, when the naked-eye 3D display window 201 is shrunk, the parallax between the left-eye image and the right-eye image can decrease significantly, which can cause the naked-eye 3D display effect to be inconspicuous.

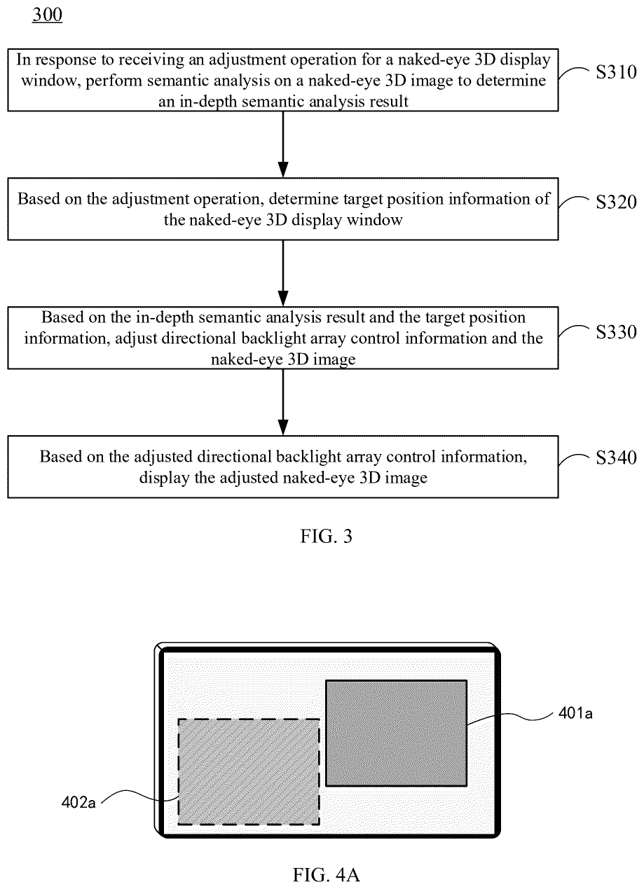

FIG. 3 is a schematic flowchart of a naked-eye 3D adjustment method according to some embodiments of the present disclosure.

In some embodiments, as shown in FIG. 3, the method 300 includes operations S310 to S340.

At S310, in response to receiving an adjustment operation for the naked-eye 3D display window, a semantic analysis is performed on the naked-eye 3D image to determine an in-depth semantic analysis result.

A S320, based on the adjustment operation, target position information of the naked-eye 3D display window is determined.

At S330, based on the in-depth semantic analysis result and the target position information, directional backlight array control information, and the naked-eye 3D image are adjusted. The directional backlight array control information is used to implement naked-eye 3D display of the naked-eye 3D image.

At S340, based on the adjusted directional backlight array control information, the adjusted naked-eye 3D image is displayed.

In embodiments of the present disclosure, a naked-eye 3D image can be displayed within the naked-eye 3D display window. In response to receiving the user adjustment operation for the naked-eye 3D display window, semantic analysis can be performed on the naked-eye 3D image to determine an in-depth semantic analysis result. The in-depth semantic analysis result may be used to determine the depth semantic information of the naked-eye 3D image.

In embodiments of the present disclosure, position information of the naked-eye 3D display window can include window boundary coordinates of the naked-eye 3D display window, and the window position and window size can be determined based on the window boundary coordinates. For example, the naked-eye 3D display window can be rectangular, and the window boundary coordinates of the naked-eye 3D display window may be expressed as [(Xa, Ya):(Xb, Yb)], where (Xa, Ya) is the coordinate of the upper-left corner of the window and (Xb, Yb) is the coordinate of the lower-right corner of the window. For example, based on the window boundary coordinates [(Xa, Ya), (Xb, Yb)], the upper-right corner coordinate of the window can be determined as (Xb, Ya), and the lower-left corner coordinate of the window can be determined as (Xa, Yb). Then, the position of the window can be determined. For example, based on the window boundary coordinates [(Xa, Ya), (Xb, Yb)], the window width can be determined as |Xb−Xa|, and the window height can be determined as |Yb−Ya|, and the dimension of the window can be determined as |Xb−Xa|×|Yb−Ya|.

In embodiments of the present disclosure, target position information of the naked-eye 3D display window can be determined based on the adjustment operation. The target position information can be understood as position information of the naked-eye 3D display window at a next backlight refresh moment. The target position information can represent the window position and window size of the naked-eye 3D display window at the next backlight refresh moment, and the target position information may be used to determine changes in the position and size of the naked-eye 3D display window during the adjustment process.

When the adjustment operation is performed on the naked-eye 3D display window, the position and the size of the naked-eye 3D display window can change. Since the 3D mode area of the directional backlight array corresponds to the naked-eye 3D display window, and the naked-eye 3D image is displayed within the naked-eye 3D display window, the control information of the directional backlight array and the naked-eye 3D image can be synchronously adjusted to maintain the accuracy and stability of the 3D display effect during the adjustment process.

In embodiments of the present disclosure, the directional backlight array control information and the naked-eye 3D image can be adjusted based on the in-depth semantic analysis result and the target position information. By combining the in-depth semantic analysis result and the target position information, changes in the position and size of the naked-eye 3D display window and the depth semantic information of the naked-eye 3D image can be sufficiently considered. Then, the directional backlight array control information and the naked-eye 3D image can be more precisely adjusted to ensure the accuracy of the 3D display effect and visual comfort during the adjustment process.

For example, control information related to the 3D mode area of the directional backlight array can be adjusted to ensure that, during the adjustment process, the left-eye image and the right-eye image can alternately and accurately enter the left eye and right eye of the viewer. For example, the display position, the image size, and the image content of the naked-eye 3D display image can be adjusted to ensure the 3D display effect of the naked-eye 3D image during the adjustment process.

In embodiments of the present disclosure, based on adjusted directional backlight array control information, the adjusted naked-eye 3D image can be displayed within the naked-eye 3D display window. By displaying the adjusted naked-eye 3D image based on the adjusted directional backlight array control information, loss or inaccuracy of the 3D display effect during the adjustment process can be effectively prevented. The accuracy, stability, and continuity of the 3D display effect during the adjustment process can be maintained to ensure that the viewer has a relatively good 3D visual experience during the adjustment process.

In embodiments of the present disclosure, by performing semantic analysis on the naked-eye 3D image, an in-depth semantic analysis result can be determined. The target position information of the naked-eye 3D window can be determined based on the adjustment operation. Then, the directional backlight array control information and the naked-eye 3D image can be adaptively and timely adjusted according to the in-depth semantic analysis result and the target position information, and the adjusted naked-eye 3D image can be displayed based on the adjusted directional backlight array control information to maintain the accuracy, stability, and continuity of the 3D display effect during the adjustment process. Thus, the viewer can be ensured to have a good naked-eye 3D visual experience.

In embodiments of the present disclosure, the operation type of the adjustment operation can include a translation operation or a scaling operation.

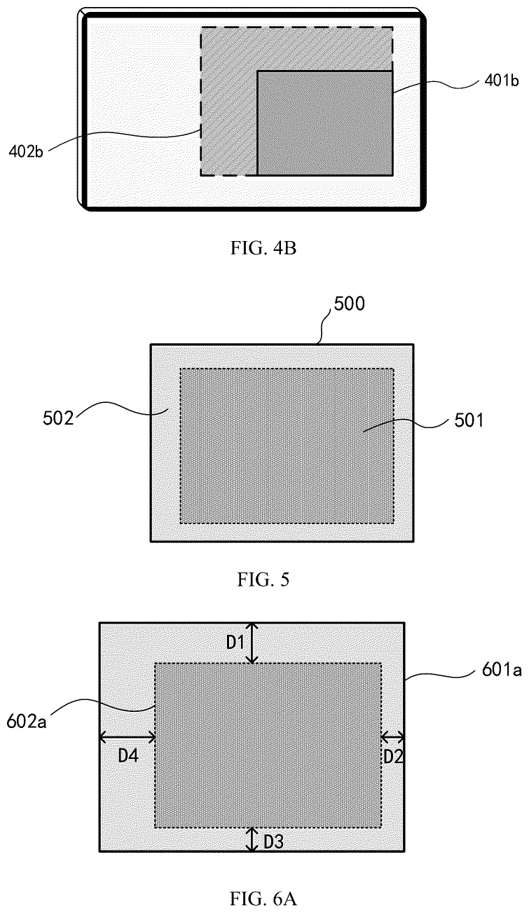

FIG. 4A is a schematic diagram of performing the adjustment operation on the naked eye display window according to some embodiments of the present disclosure.

In embodiments of the present disclosure, as shown in FIG. 4A, a translation operation can be performed on the naked-eye 3D display window. The position information of the naked-eye 3D display window changes from current position information 401a to target position information 402a. The translation operation can cause the naked-eye 3D display window to change in position.

FIG. 4B is a schematic diagram of performing another adjustment operation on the naked eye display window according to some embodiments of the present disclosure.

In some other embodiments of the present disclosure, as shown in FIG. 4B, the scaling operation is performed on the naked-eye 3D display window. The position information of the naked-eye 3D display window changes from current position information 401b to target position information 402b. The scaling operation can cause the naked-eye 3D display window to change in position and size.

In embodiments of the present disclosure, in response to receiving the adjustment operation for the naked-eye 3D display window, performing the semantic analysis on the naked-eye 3D image to determine the in-depth semantic analysis result can include, in response to receiving the adjustment operation, obtaining the naked-eye 3D image in the naked-eye 3D display window, performing feature extraction on the naked-eye 3D image based on the in-depth semantic analysis model to obtain the depth features, and determining the in-depth semantic analysis result based on the depth features.

In embodiments of the present disclosure, in response to receiving the adjustment operation, the naked-eye 3D image displayed in the naked-eye 3D display window can be obtained. For example, the naked-eye 3D image can include at least one of the left-eye image or the right-eye image. The adjustment operation can be triggered by, including but not limited to, operation manner such as mouse operations, keyboard operations, or gesture operations, or may be triggered by any other operation manner, which is not limited here. The naked-eye 3D image can be obtained by, including but not limited to, window screenshot or media file acquisition, or can be obtained by any other acquisition manner, which is not limited here.

In embodiments of the present disclosure, feature extraction can be performed on the naked-eye 3D image based on an in-depth semantic analysis model to obtain depth features. The depth features can be used to represent depth values of pixels in the naked-eye 3D image, and a depth value of a pixel can reflect the distance of the pixel from an observer. For example, the in-depth semantic analysis model can be configured to generate a depth map according to the naked-eye 3D image to extract the depth value of each pixel. Based on this, the in-depth semantic analysis result can be determined based on the depth map. For example, the depth semantic information can be used to represent whether the pixel has a stereoscopic display effect.

Merely as an example, the in-depth semantic analysis model can be selected as a monocular depth estimation (MDE) model. The model structure of the in-depth semantic analysis model is not limited in embodiments of the present disclosure.

In embodiments of the present disclosure, determining the target position information of the naked-eye 3D display window based on the adjustment operation can include analyzing the adjustment operation based on current position information of the naked-eye 3D display window to determine an adjustment speed of the adjustment operation, and determining the target position information of the naked-eye 3D display window according to the current position information, the adjustment speed, and a time interval of backlight refresh.

In embodiments of the present disclosure, the current position information of the naked-eye 3D display window can be understood as the position information of the naked-eye 3D display window at the current backlight refresh moment. The current position information can be used to represent a window position and a window size of the naked-eye 3D display window at the current backlight refresh moment. The adjustment operation can be analyzed based on the current position information to determine the adjustment speed of the adjustment operation.

In embodiments of the present disclosure, the time interval of backlight refresh can be understood, for example, as a time interval of flickering of the directional backlight array. The target position information can be determined according to the current position information, the adjustment speed, and the time interval of backlight refresh.

For example, when the translation operation is performed on the naked-eye 3D display window, a moving distance of the naked-eye 3D display window can be determined according to the adjustment speed and the time interval of backlight refresh. The moving distance can be decomposed into a horizontal direction and a vertical direction to determine a horizontal displacement and a vertical displacement. The target position information can be determined according to the current position information, the horizontal displacement, and the vertical displacement.

For another example, when a scaling operation is performed on the naked-eye 3D display window, a width change value and a height change value of the naked-eye 3D display window can be determined according to the adjustment speed and the time interval of backlight refresh. The target position information can be determined according to the current position information, the width change value, and the height change value. A scaling center and a scaling factor of the scaling operation can be determined according to the current position information and the target position information.

In embodiments of the present disclosure, analyzing the adjustment operation based on current position information of the naked-eye 3D display window to determine the adjustment speed of the adjustment operation can include determining a plurality of pieces of historical position information of the naked-eye 3D display window based on a plurality of historical backlight refresh moments, and analyzing the adjustment operation according to the current position information and the plurality of pieces of historical position information to determine the adjustment speed of the adjustment operation.

In embodiments of the present disclosure, a plurality of pieces of historical position information of the naked-eye 3D display window can be determined based on a plurality of historical backlight refresh moments during the adjustment process. The adjustment speed of the adjustment operation can be determined according to the current position information and the plurality of pieces of historical position information.

For example, the current backlight refresh moment can be moment t, the next backlight refresh moment can be moment t+1, and the plurality of historical backlight refresh moments can include moments t−3, t−2, and t−1. The plurality of pieces of historical position information and the current position information arranged in a time sequence can include Pₜ₋₃, Pₜ₋₂, Pₜ₋₁, and Pₜ. According to the plurality of pieces of historical position information and the current position information, speeds at moments t−3, t−2, and t−1 can be calculated as Vₜ₋₃, Vₜ₋₂, and Vₜ₋₁, respectively. Then, based on the adjustment speeds of the plurality of historical backlight refresh moments, an adjustment speed Vt at the current backlight refresh moment (moment t) can be determined. For example, the speed at moment t can be determined based on a linear fitting method.

In some embodiments, the plurality of pieces of historical position information and the current position information can be input into a deep learning model to obtain the adjustment speed Vt at the current backlight refresh moment (moment t).

In embodiments of the present disclosure, adjusting the directional backlight array control information and the naked-eye 3D image based on the in-depth semantic analysis result and the target position information can include determining, according to the in-depth semantic analysis result, out-of-screen and in-screen areas and a zero-plane area in the naked-eye 3D image, determining, according to the current position information and the target position information of the naked-eye 3D display window, an adjustment type of the adjustment operation, and determining an newly added naked-eye 3D display area, adjusting the directional backlight array control information based on the zero-plane area and the newly added naked-eye 3D display area, and adjusting the naked-eye 3D image based on the adjustment type.

In embodiments of the present disclosure, a depth value of each pixel in the naked-eye 3D image can be used to reflect whether the pixel has an out-of-screen display effect, an in-screen display effect, or no stereoscopic display effect. If the depth value is zero, no stereoscopic display effect can be provided. If the depth value is smaller (negative), the out-of-screen intensity can be greater. If the depth value is larger (positive), the in-screen intensity can be greater.

In embodiments of the present disclosure, the out-of-screen and in-screen areas and the zero-plane area in the naked-eye 3D image can be determined according to the in-depth semantic analysis result. The out-of-screen and in-screen areas can be understood as areas in the naked-eye 3D image that have out-of-screen or in-screen intensity. The zero-plane area can be understood as an area in the naked-eye 3D image that has no stereoscopic display effect.

FIG. 5 is a schematic diagram of the naked-eye 3D image according to some embodiments of the present disclosure.

As shown in FIG. 5, pixels in the out-of-screen and in-screen area 501 have out-of-screen and in-screen intensity, and pixels in the zero-plane area 502 are located on a zero plane. For example, the naked-eye 3D display window can be, for example, a video player window, and the naked-eye 3D image 500 can be an image displayed in the video player window. For example, the out-of-screen and in-screen area 501 can display, for example, a naked-eye 3D video, and the naked-eye 3D video can have the out-of-screen and in-screen intensity. The zero-plane area 502 can include, but is not limited to, a function bar of the video player and video black borders, which do not have a stereoscopic display effect. During the adjustment of the naked-eye 3D display window, pixels in the out-of-screen and in-screen area 501 can be accurately and stably displayed in 3D to ensure accuracy of the 3D display effect and visual comfort during the adjustment process.

In embodiments of the present disclosure, the operation type of the adjustment operation can be determined according to the current position information and the target position information. For example, changes of the naked-eye 3D display window in window position and window size can be determined according to the current position information and the target position information to determine the operation type of the adjustment operation. The operation type can include a translation operation or a scaling operation.

In embodiments of the present disclosure, the newly added naked-eye 3D display area can be determined according to the current position information and the target position information. The newly added naked-eye 3D display area can be understood as a newly added naked-eye 3D display region of the target position information relative to the current position information.

In some embodiments, based on the zero-plane area and the newly added naked-eye 3D display area, the control information related to the 3D mode area of the directional backlight array can be adjusted to ensure that the backlight corresponding to the newly added naked-eye 3D display area can be accurately projected to the left eye and right eye of the viewer.

In embodiments of the present disclosure, the naked-eye 3D image can be adjusted based on the adjustment type. For example, during performing the translation operation on the naked-eye 3D display window, a display position of the naked-eye 3D image may need to be adjusted to keep the naked-eye 3D display image moving synchronously with the naked-eye 3D display window. For another example, during performing a scaling operation on the naked-eye 3D display window, the display position, the image size, and the image content of the naked-eye 3D image may need to be adjusted to keep the naked-eye 3D image adapted to the naked-eye 3D display window and control image parallax within a reasonable range.

In embodiments of the present disclosure, determining the adjustment type of the adjustment operation and determining the newly added naked-eye 3D display area according to the current position information and the target position information of a naked-eye 3D display window can include determining the adjustment type according to differences of the target position information relative to the current position information and determining the non-overlapping area of the target position information relative to the current position information as the newly added naked-eye 3D area.

In embodiments of the present disclosure, the adjustment type can be determined according to the differences of the target position information relative to the current position information. The differences of the target position information relative to the current position information can indicate changes of the naked-eye 3D display window in window position and window size. For example, if the window size remains unchanged and only the window position changes, the adjustment type can be determined as a translation operation. If both the window size and the window position change, the adjustment type can be determined as a scaling operation.

In embodiments of the present disclosure, the non-overlapping area of the target position information relative to the current position information can be determined as the newly added naked-eye 3D area. For example, an overlapping area can be determined according to the intersection of the target position information and the current position information. The non-overlapping area can be determined based on the target position information and the overlapping area, and the non-overlapping area can be a naked-eye 3D display region that needs to be newly added.

In embodiments of the present disclosure, the directional backlight array control information can include the position information of the 3D mode area and the enabling time of the 3D mode area. Adjusting the directional backlight array control information based on the zero-plane area and the newly added naked-eye 3D display area can include determining a width of the zero-plane area based on an inner boundary of the zero-plane area and an outer boundary of the naked-eye 3D display window, determining the position information of the target 3D mode area based on the newly added naked-eye 3D display area and the width of the zero-plane area, and determining the enabling time of the newly added 3D mode area to be before the next backlight refresh moment.

In embodiments of the present disclosure, the control information of the directional backlight array can include the position information of the 3D mode area and the enabling moment of the 3D mode area.

In embodiments of the present disclosure, the position information of the 3D mode area can include coordinates of the directional backlight units located at the boundary of the 3D mode area. Based on the position information of the 3D mode area, the directional backlight units that need to enable the 3D display mode can be determined. The position information of the 3D mode area can correspond to the window boundary coordinates of the naked-eye 3D display window. For example, the first 3D mode area of the directional backlight array can be determined according to the current position information of the naked-eye 3D display window. For example, the second 3D mode area of the directional backlight array can be determined according to the target position information of the naked-eye 3D display window. Further, the overlapping 3D mode area can be determined according to the first 3D mode area and the second 3D mode area. By subtracting the overlapping 3D mode area from the second 3D mode area, the newly added 3D mode area of the directional backlight array can be obtained. The newly added 3D mode area can correspond to the newly added naked-eye 3D display area described above.

In embodiments of the present disclosure, the enabling moment of the 3D mode area can be understood as a moment at which the display mode of each directional backlight unit in the 3D mode area can be adjusted to enable the 3D display mode. For example, at time t1, the 3D display mode of each directional backlight unit in area S1 may be enabled, and at time t2, the 3D display mode of each directional backlight unit in area S2 may be enabled.

In embodiments of the present disclosure, the width of the zero-plane area can be determined based on the inner boundary of the zero-plane area and the outer boundary of the naked-eye 3D display window. The width of the zero-plane area can represent a distance between the zero-plane display portion and the edge of the naked-eye 3D display window. During the adjustment process, the width of the zero-plane area can remain unchanged.

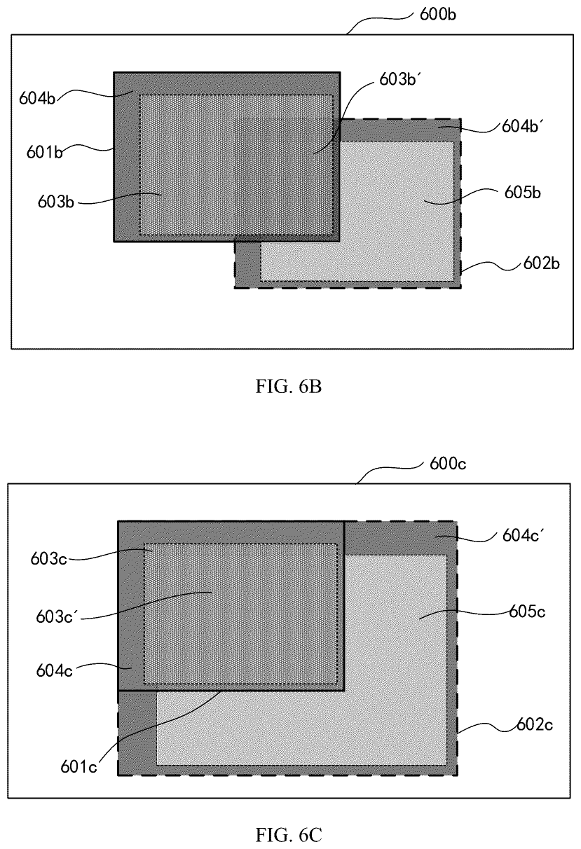

FIG. 6A is a schematic diagram showing the width of a zero-plane area according to some embodiments of the present disclosure.

As shown in FIG. 6A, the width of the zero-plane area is determined according to an inner boundary 602a of the zero-plane area and an outer boundary 601a of the naked-eye 3D display window. For example, the width of the zero-plane area includes a first width D1, a second width D2, a third width D3, and a fourth width D4.

In embodiments of the present disclosure, the naked-eye 3D display window can correspond to the 3D mode area of the directional backlight array. The naked-eye 3D image can be displayed in the naked-eye 3D display window. Thus, the naked-eye 3D image can correspond to the 3D mode area of the directional backlight array.

In embodiments of the present disclosure, the 3D mode area can include a first sub-area corresponding to an out-of-screen and in-screen area, and a second sub-area corresponding to the zero-plane area. The directional backlight units in the first sub-area and the second sub-area can enable the 3D display mode.

During the adjustment of the naked-eye 3D display window, each directional backlight unit in the first sub-area is ensured to be enabled with the 3D display mode to ensure the out-of-screen and in-screen to normally display the 3D visual effect. Accordingly, the first sub-area of the directional backlight units may also need to be synchronously updated. If the adjustment speed for the naked-eye 3D display window is too fast, the directional backlight units in the corresponding first sub-area may not be able to enable the 3D display mode on time. Then, the 3D display effect of a portion of the content in the naked-eye 3D image can be lost.

In embodiments of the present disclosure, the target 3D mode area can be understood as an area in the target first sub-area corresponding to a next backlight refresh moment that does not enable the 3D display mode at a current backlight refresh moment.

In some embodiments, the first 3D mode area can include the current first sub-area corresponding to the out-of-screen and in-screen area, and the current second sub-area corresponding to the zero-plane area. The second 3D mode area can include the target first sub-area corresponding to the out-of-screen and in-screen area, and the target second sub-area corresponding to the zero-plane area. During adjustment, if the target first sub-area exceeds a range of the first 3D mode area, the exceeding portion can be determined as the target 3D mode area. To ensure the 3D display effect of the out-of-screen and in-screen area, the target 3D mode area can be enabled in advance. That is, the directional backlight units in the target 3D mode area may be enabled to enter the 3D display mode in advance. If the target first sub-area does not exceed the range of the first 3D mode area, advance processing may not be performed.

In embodiments of the present disclosure, the position information of the target 3D mode area can be determined based on the newly added naked-eye 3D display area and the width of the zero-plane area. For example, the newly added 3D mode area can be determined according to the added naked-eye 3D display region. When the target first sub-area exceeds the range of the first 3D mode area, the width of the zero-plane area may be correspondingly subtracted from the newly added 3D mode area to obtain the target 3D mode area. Then, the position information of the target 3D mode area can be determined.

FIG. 6B is a schematic diagram of the newly added 3D mode area according to some embodiments of the present disclosure.

As shown in FIG. 6B, in a directional backlight array 600b, a first 3D mode area 601b corresponding to the current position information of the naked-eye 3D display window is provided. At the current backlight refresh moment, a 3D display mode of each directional backlight unit within the first 3D mode region 601b is enabled, and a 3D display mode of each directional backlight unit outside the first 3D mode region 601b is not enabled.

As shown in FIG. 6B, in the directional backlight array 600b, a second 3D mode area 602b corresponding to the target position information of the naked-eye 3D display window is provided. At the next backlight refresh moment, a 3D display mode of each directional backlight unit within the second 3D mode area 602b needs to be enabled.

As shown in FIG. 6B, the first 3D mode area 601b includes the current first sub-area 603b corresponding to the out-of-screen and in-screen area, and the current second sub-area 604b corresponding to the zero-plane area. The second 3D mode area 602b includes the target first sub-area 603b′ corresponding to the out-of-screen and in-screen area, and the target second sub-area 604b′ corresponding to the zero-plane area. The target 3D mode area 605b is located within the target first sub-area 603b′ of the second 3D mode area 602b, and the directional backlight units within the target 3D mode area 605b have not enabled the 3D display mode.

In embodiments of the present disclosure, an enabling moment of the target 3D mode area 605b can be determined to be before the next backlight refresh moment. That is, each directional backlight unit within the target 3D mode area 605b can be enabled to enter the 3D display mode before the next backlight refresh moment.

FIG. 6C is a schematic diagram of another target 3D mode area according to some embodiments of the present disclosure.

As shown in FIG. 6C, in the directional backlight array 600c, the first 3D mode area 601c corresponding to the current position information of the naked-eye 3D display window is provided. At the current backlight refresh moment, the 3D display mode of each directional backlight unit within the first 3D mode area 601c is enabled, and the 3D display mode of each directional backlight unit outside the first 3D mode area 601c is not enabled.

As shown in FIG. 6C, in the directional backlight array 600c, the second 3D mode area 602c corresponding to the target position information of the naked-eye 3D display window. At the next backlight refresh moment, the 3D display mode of each directional backlight unit within the second 3D mode area 602c needs to be enabled.

As shown in FIG. 6C, the first 3D mode area 601c includes the current first sub-area 603c corresponding to the out-of-screen and in-screen area, and the current second sub-area 604c corresponding to the zero-plane area. The second 3D mode area 602c includes the target first sub-area 603c′ corresponding to the out-of-screen and in-screen area, and the target second sub-area 604c′ corresponding to the zero-plane area. The target 3D mode area 605c is located within the target first sub-area 603c′ of the second 3D mode area 602c, and the directional backlight units within the target 3D mode area 605c have not been enabled.

In embodiments of the present disclosure, the enabling moment of the target 3D mode area 605c can be determined to be before the next backlight refresh moment. That is, each directional backlight unit within the target 3D mode area 605c may need to be enabled to enter the 3D display mode before the next backlight refresh moment.

In embodiments of the present disclosure, by enabling the 3D display mode of the directional backlight units within the target 3D mode area in advance, the situation in which, due to an excessively fast adjustment speed, the 3D display mode of the directional backlight units within the target 3D mode area cannot be enabled in time, can be effectively avoided. Thus, accuracy, stability, and continuity of the 3D display effect during the adjustment process can be maintained. Then, the viewer can be ensured to have a relatively good 3D visual experience during the adjustment process.

In embodiments of the present disclosure, the adjustment type can include the translation operation or the scaling operation. Adjusting the naked-eye 3D image based on the adjustment type can include obtaining a to-be-displayed original naked-eye 3D image. The original naked-eye 3D image can include a first-view original image and a second-view original image. An initial baseline length can exist between the first-view original image and the second-view original image. Adjusting the naked-eye 3D image based on the adjustment type can further include determining the target baseline length based on the scaling factor of the scaling operation and the initial baseline length when the adjustment operation is the scaling operation, determining the target parallax based on the target baseline length, and generating a first-view generated image and a second-view generated image based on the first-view original image and the second-view original image according to the target parallax.

In some embodiments of the present disclosure, when the translation operation is performed on the naked-eye 3D display window, since the window size of the naked-eye 3D display window remains unchanged during the movement, and only the window position changes, only the display position of the naked-eye 3D image may need to be adjusted.

In some other embodiments of the present disclosure, when the scaling operation is performed on the naked-eye 3D display window, since both the window size and the window position of the naked-eye 3D display window change during the movement, the display position and the image size of the naked-eye 3D image may need to be adjusted. In addition, to ensure that the image parallax remains within a reasonable range during the adjustment process, the image content of the naked-eye 3D image may also need to be adjusted. In consideration of visual comfort and the 3D display effect, when a viewer enlarges or reduces the naked-eye 3D display window, a visual experience presented to the viewer should be that an object becomes larger or smaller with the operation, but the distance between the object and the viewer should not significantly change with the scaling operation. Thus, the image content of the naked-eye 3D image may need to be adjusted to allow the viewer to perceive a small degree of depth change of the object during the adjustment process.

In embodiments of the present disclosure, the first view can correspond to the left eye of the viewer, and the second view can correspond to the right eye of the viewer.

In embodiments of the present disclosure, the to-be-displayed original naked-eye 3D image can include a left-eye original image and a right-eye original image. An initial baseline length can exist between the left-eye original image and the right-eye original image. The left-eye image can correspond to a left camera, the right-eye image can correspond to a right camera, and the initial baseline length can be understood as a distance between the optical center of the left camera and the optical center of the right camera.

In embodiments of the present disclosure, the left-eye original image and the right-eye original image can be converted into physical sizes according to the size of the display panel. For a certain object in an image, based on a binocular parallax principle, the real depth of the object can be determined according to the original parallax between the converted left-eye original image, the right-eye original image, and the initial baseline length.

In embodiments of the present disclosure, an appropriate target baseline length can be determined based on the real depth of the object and the scaling factor. Then, the target parallax can be determined according to the target baseline length.

For example, the target baseline length can be determined based on the following formula:

$$B \leq \frac{{D}_{n} ( {P}_{2} - {P}_{1} )}{kf}$$

where B denotes the target baseline length, Dₙ denotes the real depth of the object, P₂ denotes a maximum positive parallax that can be displayed by the display panel, P₁ denotes a maximum negative parallax that can be displayed by the display panel, k denotes the scaling factor, and f denotes a camera focal length. For the same content acquisition scene, Dₙ and f can be constants, and for the same display panel, P₂−P₁ can be a constant.

For example, if the target baseline length is smaller than the initial baseline length, a target viewpoint can be determined through viewpoint interpolation. If the target baseline length is greater than the initial baseline length, the target viewpoint can be determined through viewpoint extrapolation. The target viewpoint can be understood as a target left camera position and a target right camera position corresponding to the target baseline length.

In embodiments of the present disclosure, the target parallax can be determined according to the target viewpoint and the real depth of the object. According to the target parallax, the left-eye generated image and the right-eye generated image can be generated based on the left-eye original image and the right-eye original image. For example, techniques such as 3D Gaussian splatting reconstruction, diffusion models, and optical flow interpolation techniques can be used to generate the left-eye generated image and the right-eye generated image, which is not limited.

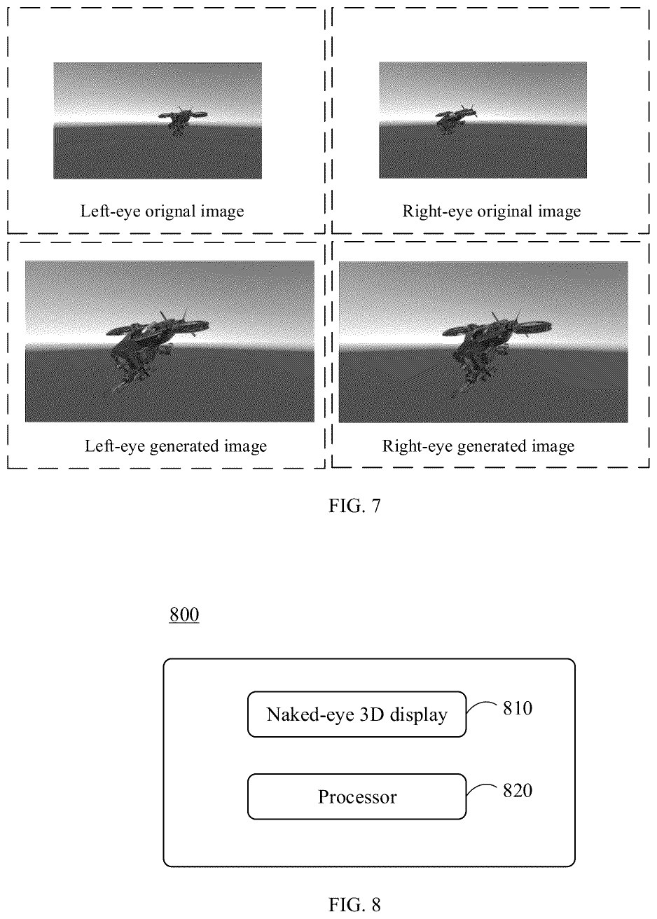

FIG. 7 is a schematic diagram of a left-eye image and a right-eye image before adjustment and a left-eye image and a right-eye image after adjustment according to some embodiments of the present disclosure.

As shown in FIG. 7, when a viewer enlarges the naked-eye 3D display window, the adjusted left-eye generated image and the adjusted right-eye generated image can be generated based on the left-eye original image and the right-eye original image according to the target parallax. Then, a visual experience of the object becoming larger with the operation without having significant changes in the position of the object from the viewer with the scaling operation can be provided to the viewer.

In embodiments of the present disclosure, the real depth of the object can be determined according to the original naked-eye 3D image. Then, the appropriate target parallax can be determined based on the real depth of the object and the scaling factor. By regenerating the left-eye image and the right-eye image according to the target parallax, the viewer can perceive a small degree of depth change of the object during the adjustment process. Then, the viewer can have a good 3D visual experience when enlarging/reducing the naked-eye 3D display window.

FIG. 8 is a schematic block diagram of an electronic device 800 according to some embodiments of the present disclosure.

As shown in FIG. 8, the electronic device 800 includes a naked-eye 3D display and at least one processor. The naked-eye 3D display includes a directional backlight array. The directional backlight array can be used for naked-eye 3D display. The at least one processor can be configured to, in response to receiving an adjustment operation for a naked-eye 3D display window, perform semantic analysis on a naked-eye 3D image to determine a in-depth semantic analysis result, determine target position information of the naked-eye 3D display window based on the adjustment operation, adjust directional backlight array control information and the naked-eye 3D image based on the in-depth semantic analysis result and the target position information, and display the adjusted naked-eye 3D image based on the adjusted directional backlight array control information. The directional backlight array control information can be used to realize the naked-eye 3D display of the naked-eye 3D image. Based on this, the electronic device 800 can be configured to implement the naked-eye 3D display adjustment method described above.

For example, the naked-eye 3D display can be selected as a naked-eye 3D display based on the directional backlight technology. For example, the naked-eye 3D display can include a directional backlight array and a display panel. The directional backlight array can include, for example, a backlight unit array, a lens array, or a diffusion film layer. In some embodiments, the naked-eye 3D display can also be selected as a display based on other naked-eye 3D display technologies, which are not limited.

For example, the processor can include, for example, a general-purpose microprocessor, an instruction set processor and/or an associated chipset, and/or a special-purpose microprocessor (for example, an application specific integrated circuit (ASIC)), and the like. The processor can further include on-board memory for caching purposes. The processor 510 can be a single processing unit or a plurality of processing units configured to perform different actions of the naked-eye 3D display adjustment method described above.

Various embodiments of the systems and techniques described above can be implemented in digital electronic circuit systems, integrated circuit systems, field programmable gate arrays (FPGA), application specific integrated circuits (ASIC), application specific standard products (ASSP), systems on chip (SOC), complex programmable logic devices (CPLD), computer hardware, firmware, software, and/or combinations thereof. These embodiments can include implementations in one or more computer programs. The one or more computer programs can be executed and/or described on the programmable system including at least one programmable processor. The programmable processor can be a special-purpose or general-purpose programmable processor, which can receive data and instructions from the storage system, at least one input apparatus, and at least one output apparatus, and transmit the data and the instructions to the storage system, the at least one input apparatus, and the at least one output apparatus.

Program codes for implementing the method of the present disclosure can be written in any combination of one or more programming languages. Such program codes can be provided to processors or controllers of general-purpose computers, special-purpose computers, or other programmable data processing apparatuses. Thus, when the program codes are executed by the processors or controllers, the functions/operations specified in the flowcharts and/or block diagrams can be implemented. The program code can be executed entirely on a machine, partly on a machine, partly on a machine as a stand-alone software package and partly on a remote machine, or entirely on a remote machine or server.

In the context of the present disclosure, a machine-readable medium can be a tangible medium that can contain or store a program for use by, or in connection with, an instruction execution system, apparatus, or device. The machine-readable medium can be a machine-readable signal medium or a machine-readable storage medium. The machine-readable medium can include, but is not limited to, electronic, magnetic, optical, electromagnetic, infrared, or semiconductor systems, apparatuses, or devices, or any suitable combination thereof. More specific examples of the machine-readable storage medium can include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The systems and technologies described here can be implemented in a computing system including backend components (for example, as a data server), or a computing system including middleware components (for example, an application server), or a computing system including frontend components (for example, a user computer having a graphical user interface or a web browser through which the user can interact with implementations of the systems and technologies described here), or a computing system including any combination of such backend components, middleware components, or frontend components. The components of the system can be interconnected by any form or medium of digital data communication (for example, a communication network). Examples of communication networks can include a local area network (LAN), a wide area network (WAN), and the Internet.

The computer system can include a client and a server. The client and the server are generally away from each other and typically interact through a communication network. The client-server relationship can be generated by computer programs running on corresponding computers that have the client-server relationship with each other. The server can be a cloud server, a server of a distributed system, or a server combined with blockchain technology.

Various forms of processes shown above can be used to reorder, add, or delete steps. For example, the steps described in the present disclosure can be executed in parallel, in sequence, or in a different order, as long as the expected results of the technical solution of the present disclosure can be achieved, which is not limited.

Those skilled in the art can understand that the features recorded in various embodiments and/or claims of the present disclosure can be grouped and/or combined in various ways, even if such combinations or integrations are not explicitly described in the present disclosure. In particular, without departing from the spirit and teaching of the present disclosure, the features recorded in the various embodiments and/or claims of the present disclosure can be combined and/or integrated in various ways. All such combinations and/or integrations fall within the scope of the present disclosure.

Although the present disclosure has been shown and described with reference to specific exemplary embodiments thereof, those skilled in the art should understand that various changes in form and detail can be made to the present disclosure without departing from the spirit and scope of the present disclosure as defined by the appended claims and their equivalents. Therefore, the scope of the present disclosure should not be limited to the above embodiments, but should be defined not only by the appended claims but also by the equivalents of the appended claims.

What is claimed is:

1. A naked-eye 3D display adjustment method comprising:
in response to receiving an adjustment operation for a naked-eye 3D display window, performing semantic analysis on a naked-eye 3D image to determine an in-depth semantic analysis result;
based on the adjustment operation, determining target position information of the naked-eye 3D display window;
based on the in-depth semantic analysis result and the target position information, adjusting directional backlight array control information and the naked-eye 3D image, wherein the directional backlight array control information is used to implement naked-eye 3D display of the naked-eye 3D image; and
based on the adjusted directional backlight array control information, displaying the adjusted naked-eye 3D image.

2. The method according to claim 1, wherein an operation type of the adjustment operation includes a translation operation or a scaling operation.

3. The method according to claim 1, wherein, in response to receiving the adjustment operation for the naked-eye 3D display window, performing the semantic analysis on the naked-eye 3D image to determine the in-depth semantic analysis result includes:
in response to receiving the adjustment operation, obtaining the naked-eye 3D image in the naked-eye 3D display window;
based on an in-depth semantic analysis model, performing feature extraction on the naked-eye 3D image to obtain depth features; and
based on the depth features, determining the in-depth semantic analysis result.

4. The method according to claim 1, wherein based on the adjustment operation, determining the target position information of the naked-eye 3D display window includes:
based on current position information of the naked-eye 3D display window, analyzing the adjustment operation to determine an adjustment speed of the adjustment operation; and
according to the current position information, the adjustment speed, and a backlight refresh time interval, determining the target position information of the naked-eye 3D display window.

5. The method according to claim 4, wherein, based on the current position information of the naked-eye 3D display window, analyzing the adjustment operation to determine the adjustment speed of the adjustment operation includes:
based on a plurality of historical backlight refresh moments, determining a plurality of pieces of historical position information of the naked-eye 3D display window; and
according to the current position information and the plurality of pieces of historical position information, analyzing the adjustment operation to determine the adjustment speed of the adjustment operation.

6. The method according to claim 1, wherein, based on the in-depth semantic analysis result and the target position information, adjusting the directional backlight array control information and the naked-eye 3D image includes:
according to the in-depth semantic analysis result, determining an in-screen/out-of-screen area and a zero-plane area in the naked-eye 3D image;
according to current position information and the target position information of the naked-eye 3D display window, determining an adjustment type of the adjustment operation and a newly added naked-eye 3D display area;
based on the zero-plane area and the newly added naked-eye 3D display area, adjusting the directional backlight array control information; and
based on the adjustment type, adjusting the naked-eye 3D image.

7. The method according to claim 6, wherein, according to the current position information and the target position information of the naked-eye 3D display window, determining the adjustment type of the adjustment operation and the newly added naked-eye 3D display area includes:
according to a difference of the target position information relative to the current position information, determining the adjustment type; and
determining a non-overlapping area of the target position information relative to the current position information as the newly added naked-eye 3D display area.

8. The method according to claim 6, wherein:
the directional backlight array control information includes position information of a 3D mode area and an enabling moment of the 3D mode area; and
based on the zero-plane area and the newly added naked-eye 3D display area, adjusting the directional backlight array control information includes:
based on an inner boundary of the zero-plane area and an outer boundary of the naked-eye 3D display window, determining a width of the zero-plane area;
based on the newly added naked-eye 3D display area and a width of the zero-plane area, determining position information of a target 3D mode area; and
determining the enabling moment of the target 3D mode area to be before a next backlight refresh moment.

9. The method according to claim 6, wherein:
the adjustment type includes a translation operation or a scaling operation; and
based on the adjustment type, adjusting the naked-eye 3D image includes:
obtaining a to-be-displayed original naked-eye 3D image, wherein the original naked-eye 3D image includes a first-view original image and a second-view original image, and an initial baseline length exists between the first-view original image and the second-view original image;
in response to the adjustment operation being a scaling operation, based on a scaling factor of the scaling operation and the initial baseline length, determining a target baseline length;
based on the target baseline length, determining a target parallax; and
according to the target parallax, based on the first-view original image and the second-view original image, generating a first-view generated image and a second-view generated image.

10. An electronic device, comprising:
a naked-eye 3D display, wherein the naked-eye 3D display includes a directional backlight array, and the directional backlight array is configured for naked-eye 3D display; and
at least one processor configured to:
in response to receiving an adjustment operation for a naked-eye 3D display window, perform semantic analysis on a naked-eye 3D image to determine an in-depth semantic analysis result;
based on the adjustment operation, determine target position information of the naked-eye 3D display window;
based on the in-depth semantic analysis result and the target position information, adjust directional backlight array control information and the naked-eye 3D image, wherein the directional backlight array control information is used to implement naked-eye 3D display of the naked-eye 3D image; and
based on the adjusted directional backlight array control information, display the adjusted naked-eye 3D image.

11. The electronic device according to claim 10, wherein an operation type of the adjustment operation includes a translation operation or a scaling operation.

12. The electronic device according to claim 10, wherein the at least one processor is further configured to:
in response to receiving the adjustment operation, obtain the naked-eye 3D image in the naked-eye 3D display window;
based on an in-depth semantic analysis model, perform feature extraction on the naked-eye 3D image to obtain depth features; and
based on the depth features, determine the in-depth semantic analysis result.

13. The electronic device according to claim 10, wherein the at least one processor is further configured to:
based on current position information of the naked-eye 3D display window, analyze the adjustment operation to determine an adjustment speed of the adjustment operation; and
according to the current position information, the adjustment speed, and a backlight refresh time interval, determine the target position information of the naked-eye 3D display window.

14. The electronic device according to claim 13, wherein the at least one processor is further configured to:
based on a plurality of historical backlight refresh moments, determine a plurality of pieces of historical position information of the naked-eye 3D display window; and
according to the current position information and the plurality of pieces of historical position information, analyze the adjustment operation to determine the adjustment speed of the adjustment operation.

15. The electronic device according to claim 10, wherein the at least one processor is further configured to:
according to the in-depth semantic analysis result, determine an in-screen/out-of-screen area and a zero-plane area in the naked-eye 3D image;
according to current position information and the target position information of the naked-eye 3D display window, determine an adjustment type of the adjustment operation and a newly added naked-eye 3D display area;
based on the zero-plane area and the newly added naked-eye 3D display area, adjust the directional backlight array control information; and
based on the adjustment type, adjust the naked-eye 3D image.

16. The electronic device according to claim 15, wherein the at least one processor is further configured to:
according to a difference of the target position information relative to the current position information, determine the adjustment type; and
determine a non-overlapping area of the target position information relative to the current position information as the newly added naked-eye 3D display area.

17. The electronic device according to claim 15, wherein:
the directional backlight array control information includes position information of a 3D mode area and an enabling moment of the 3D mode area; and
the at least one processor is further configured to:
based on an inner boundary of the zero-plane area and an outer boundary of the naked-eye 3D display window, determine a width of the zero-plane area;
based on the newly added naked-eye 3D display area and a width of the zero-plane area, determine position information of a target 3D mode area; and
determine the enabling moment of the target 3D mode area to be before a next backlight refresh moment.

18. The electronic device according to claim 15, wherein:
the adjustment type includes a translation operation or a scaling operation; and
the at least one processor is further configured to:
obtain a to-be-displayed original naked-eye 3D image, wherein the original naked-eye 3D image includes a first-view original image and a second-view original image, and an initial baseline length exists between the first-view original image and the second-view original image;
in response to the adjustment operation being a scaling operation, based on a scaling factor of the scaling operation and the initial baseline length, determine a target baseline length;
based on the target baseline length, determine a target parallax; and
according to the target parallax, based on the first-view original image and the second-view original image, generate a first-view generated image and a second-view generated image.

19. A computer-readable storage medium storing program codes that, when executed by one or more processors, cause the one or more processors to:
in response to receiving an adjustment operation for a naked-eye 3D display window, perform semantic analysis on a naked-eye 3D image to determine an in-depth semantic analysis result;
based on the adjustment operation, determine target position information of the naked-eye 3D display window;
based on the in-depth semantic analysis result and the target position information, adjust directional backlight array control information and the naked-eye 3D image, wherein the directional backlight array control information is used to implement naked-eye 3D display of the naked-eye 3D image; and
based on the adjusted directional backlight array control information, display the adjusted naked-eye 3D image.

20. The computer-readable storage medium according to claim 19, wherein an operation type of the adjustment operation includes a translation operation or a scaling operation.
